(19) United States
(12) Patent Application Publication
(10) Pub. No.: US 2006/0067373 A1
(43) Pub. Date: Mar. 30, 2006

(54) Cooling device for radiation sources provided during production of a printing form

(75) Inventor: Tapani Mikael Alander, Tampere (FI)

Correspondence Address: LERNER GREENBERG STEMER LLP, P O BOX 2480, HOLLYWOOD, FL, 33022-2480, US

(73) Assignee: Heidelberger Druckmaschinen AG

(21) Appl. No.: 11/240,758

(22) Filed: Sep. 30, 2005

(30) Foreign Application Priority Data
Sep. 30, 2004 (DE) 10 2004 048 088.5

(51) Int. Cl. H01S 3/04

(52) U.S. Cl. 372/34

(57) ABSTRACT

A cooling device for radiation sources during production of a printing form includes a metallic layer for conducting an operative current and heat. The radiation sources are formed as a semiconductor substrate and are secured onto the metallic layer. An electrically insulating, heat conducting plate has an upper side to which the metallic layer is applied. A cooling body is formed of a thermally conductive material having a thermal expansion coefficient adapted to the semiconductor substrate. The heat conducting plate is secured at a lower side thereof to the cooling body. The cooling body has at least one duct for circulating a cooling fluid.

### BACKGROUND OF THE INVENTION

### Field of the Invention

The invention relates to a cooling device for radiation sources provided during production of a printing form.

U.S. Pat. No. 6,603,498 discloses a printing head with an array of individually addressable laser diodes. The laser diodes are addressed in accordance with the image, thus creating individual beams which are guided to a surface of a non-imaged printing form by an optical system. Each beam is powerful enough to create pixels or halftone dots which accept printing ink or which repel printing ink on the non-imaged printing form. In particular for non-imaged printing forms whereon the halftone dots are created by ablating material, the radiation efficiency must be high. As the non-imaged printing form is imaged, the laser diodes heat up. To avoid failures and to extend the useful life of the laser diodes, the latter must be cooled during operation at high imaging speeds. For the purpose of cooling the laser diodes, they are secured, for example, by soldering, to a cooling body formed of a material with high thermal conductivity, such as copper. In this regard, the laser diodes are not electrically insulated from the cooling body, a condition which is not necessarily desired in every case.

German Patent DE 42 34 342 C2, corresponding to U.S. Pat. No. 5,705,788, discloses a device for treating material by laser irradiation, wherein a plurality of laser diodes are stacked upon one another to form a laser diode array. The laser diodes are mutually spaced apart by cooling plates. To obtain a high power density per area, the heat generated during operation of the laser diodes is dissipated by a liquid or gaseous cooling agent, which flows through ducts extending transversely to the cooling plates. In this regard also, the cooling plates and the laser diodes are not electrically connected. This construction with a plurality of cooling plates is quite costly.

U.S. Pat. No. 6,225,571 discloses a heat sink for a component of a printed circuit board. The component is soldered onto a metallic plate. An electrically insulating pad is provided between the plate and a cooling body. The cooling body has cooling fins by which the heat is transferred to the ambient air. This embodiment of a heat sink is unable to be used on a laser diode array having laser diodes spaced less than 200 micrometers apart.

### SUMMARY OF THE INVENTION

It is accordingly an object of the invention to provide a cooling device for radiation sources provided during production of a printing form, which overcomes the hereinafore-mentioned disadvantages of the heretofore-known devices of this general type, which affords electrical insulation between a semiconductor radiation source and a cooling body and which offers an improved cooling effect.

With the foregoing and other objects in view, there is provided, in accordance with the invention, a cooling device for radiation sources during production of a printing form. The cooling device includes a metallic layer for conducting an operative current and heat. The radiation sources are formed as a semiconductor substrate and are secured onto the metallic layer. An electrically insulating, heat conducting plate has an upper side to which the metallic layer is applied. A cooling body formed of a thermally conductive material has a thermal expansion coefficient adapted to the semiconductor substrate. The heat conducting plate is secured at an underside thereof to the cooling body. The cooling body has at least one duct for circulating a cooling fluid.

In accordance with another feature of the invention, the cooling device further includes a thermally conductive metallic layer applied to the heat conducting plate at the underside thereof.

In accordance with a further feature of the invention, the cooling device further includes a hermetically sealing soldering connection provided between the cooling body and the metallic layer on the underside of the plate.

In accordance with an added feature of the invention, the cooling device further includes a hermetically sealing welding connection provided between the cooling body and the metallic layer on the underside of the plate.

In accordance with an additional feature of the invention, the cooling device further includes a hermetically sealing adhesive connection provided between the cooling body and the metallic layer on the underside of the plate.

In accordance with yet another feature of the invention, the cooling body and the metallic layers on the upper side and the underside of the plate are formed of copper.

In accordance with yet a further feature of the invention, the plate is formed of aluminum nitride.

In accordance with yet an added feature of the invention, the duct is closed off by the metallic layer on the underside of the plate.

In accordance with yet an additional feature of the invention, water circulates within the duct.

In accordance with a concomitant feature of the invention, the radiation sources are disposed on a carrier secured onto the metallic layer.

Thus, according to the invention, a semiconductor radiation source, in particular a laser diode array, is secured to a metallic layer, which conducts an operative current and is also thermally conductive. The metallic layer is connected, so as to be thermally conductive, onto the surface of an electrically insulating and thermally conductive plate. The underside of the plate is secured onto a cooling body formed of a thermally conductive material having a thermal expansion coefficient adapted to the semiconductor substrate of the radiation source. Provided in the cooling body is a duct for circulating a cooling fluid. The cooling fluid preferably flows on the underside of the electrically insulating plate. For reasons of assembly, the underside of the plate may be provided with a solderable metallic layer having good thermal conductivity.

Other features which are considered as characteristic for the invention are set forth in the appended claims.

Although the invention is illustrated and described herein as embodied in a cooling device for radiation sources provided during the production of a printing form, it is nevertheless not intended to be limited to the details shown, since various modifications and structural changes may be made therein without departing from the spirit of the invention and within the scope and range of equivalents of the claims.

The construction and method of operation of the invention, together with additional objects and advantages thereof will be best understood from the following description of specific embodiments when read in connection with the accompanying drawings.

### BRIEF DESCRIPTION OF THE DRAWINGS

FIGS. 1 and 2 are fragmentary, diagrammatic, side-elevational and top-plan views, respectively, of an imaging head for producing a printing form.

### DESCRIPTION OF THE PREFERRED EMBODIMENTS

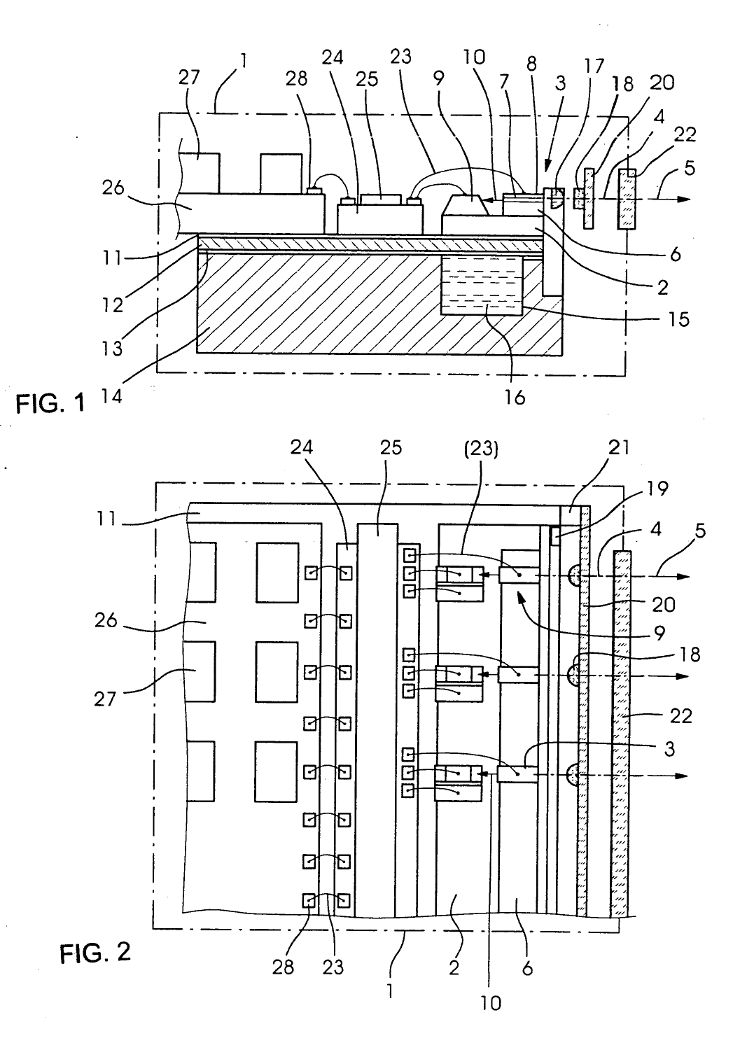

Referring now to FIGS. 1 and 2 of the drawings in detail, there is seen a laser diode array mounted on a carrier 2 with good thermal conductivity, which is provided in a hermetically sealed housing 1 filled with a protective gas. The laser diode array includes sixty-four laser diodes 3 soldered onto the carrier 2 at a spaced distance of 170 micrometers from one another along a straight line. Optical axes 4 of beams 5 emitted by the laser diodes 3 extend parallel to one another and perpendicular to the straight line. Each laser diode 3 is disposed on a substrate 6 formed of GaAs onto which a laser active layer 7 and a contacting layer 8 formed of gold are applied. Each laser diode 3 has a photodiode 9 assigned thereto in such a manner that a respective laser beam 10 from the rear facet of the laser diode 3 strikes the receiving surface of the photodiode 9.

The housing 1 further includes a cooling device or assembly having a copper layer 11, an electrically insulating, heat conducting plate 12 formed of aluminum nitride, another copper layer 13, and a cooling body 14. The insulating, heat conducting plate 12 is thicker than 0.5 mm, which provides sufficient disruptive strength for voltages of up to 500 V. The copper layer 11 is about 0.2 mm thick for dissipating the current flowing when the laser diodes 3 are addressed. The carrier 2 is soldered on the underside thereof onto the copper layer 11. The copper layer 11, the insulating, heat conducting plate 12, and the copper layer 13 form a subassembly and are in good thermal contact with one another. The copper layer 13 is soldered onto the upper side of the cooling body 14. The cooling body 14 is formed of a material having high thermal conductivity and a thermal expansion coefficient approximating that of the carrier 2. Suitable materials for the cooling body 14 are copper tungsten, copper molybdenum, tungsten, molybdenum, Kovar, Silvar, or Alloy 42. A duct 15 for cooling water 16 is formed in the cooling body 14. The cooling water 16 flows on the underside of the copper layer 13.

Within the housing 1, there are further included a cylindrical lens 17 and an array of cylindrical lenses 18 for forming the laser beams 5. The focal line of the cylindrical lenses 17 and 18 are perpendicular to one another. The focal line of the cylindrical lens 17 is parallel to the straight line of the laser diodes 3. The cylindrical lens 17 is received in a socket 19 glued or adhesively secured to the cooling body 14. The array of cylindrical lenses 18 is disposed on a coplanar glass plate 20, which is also fixed to the cooling body 14 via a support 21. On the side of the exiting light, at the right-hand side of the figures, the housing 1 is closed off by a glass plate 22. When assembling the cylindrical lenses 17 and 18 to the cooling body 14, care is taken that the optical properties of the lenses are not subject to changes due to thermally induced expansions in length. Wires 23 connect the assembly of the laser diodes 3 and the photodiodes 9 to a circuit 24 for addressing the laser diodes 3 and processing the signals of the photodiode 9. A common contact bar 25 for conducting a current is provided on the upper side of the circuit 24.

In addition, a printed circuit board 26 with components 27 is received in the housing 1. Connections are provided to the circuit 24 via contact surfaces 28 and wires 23. The circuit 24 and the printed circuit board 26 are also secured to the copper layer 11 for cooling purposes.

As noted hereinbefore, the invention is not limited to the exemplary embodiment represented herein. In particular, the connections by soldering between components can also be provided by brazing, welding, or gluing. The materials used herein are presented by way of example only and can be replaced by materials with equivalent electrical and thermal properties.

This application claims the priority, under 35 U.S.C. § 119, of German Patent Application 10 2004 048 088.5, filed Sep. 30, 2004; the entire disclosure of the prior application is herewith incorporated by reference.

I claim:

1. A cooling device for radiation sources during production of a printing form, the cooling device comprising:
an electrically insulating, heat conducting plate having an upper side and a lower side;
a metallic layer for conducting an operative current and heat, said metallic layer being applied to said upper side of said heat conducting plate;
a semiconductor substrate forming the radiation sources and being secured onto said metallic layer; and
a cooling body formed of a thermally conductive material having a thermal expansion coefficient adapted to said semiconductor substrate, said cooling body having at least one duct for circulating a cooling fluid, and said cooling body being secured to said lower side of said heat conducting plate.

2. The cooling device according to claim 1, further comprising a thermally conductive metallic layer applied to said lower side of said heat conducting plate.

3. The cooling device according to claim 2, further comprising a hermetically sealing soldering connection disposed between said cooling body and said metallic layer on said lower side of said heat conducting plate.

4. The cooling device according to claim 2, further comprising a hermetically sealing welding connection disposed between said cooling body and said metallic layer on said lower side of said heat conducting plate.

5. The cooling device according to claim 2, further comprising a hermetically sealing adhesive connection disposed between said cooling body and said metallic layer on said lower side of said heat conducting plate.

6. The cooling device according to claim 2, wherein said metallic layer applied to said upper side of said heat conducting plate and said thermally conductive metallic layer applied to said lower side of said heat conducting plate, are formed of copper.

7. The cooling device according to claim 1, wherein said heat conducting plate is formed of aluminum nitride.

8. The cooling device according to claim 2, wherein said at least one duct is closed off by said metallic layer on said lower side of said heat conducting plate.

9. The cooling device according to claim 1, wherein water circulates within said duct.

10. The cooling device according to claim 1, further comprising a carrier secured onto said metallic layer, said semiconductor substrate being disposed on said carrier.
